(19) United States
(12) Patent Application Publication
(10) Pub. No.: US 2003/0080938 A1
(43) Pub. Date: May 1, 2003

(54) Self-powered wireless device

(76) Inventors: Bin Lian, Portland, OR (US); Franklin G. Monzon, Portland, OR (US); Prateek Dujari, Portland, OR (US)

Correspondence Address: Timothy N. Trop, TROP, PRUNER & HU, P.C., 8554 KATY FWY. STE. 100, HOUSTON, TX, 77024-1805, US

(21) Appl. No.: 10/029,587

(22) Filed: Oct. 25, 2001

(51) Int. Cl. G09G 5/00; G09G 5/08

(52) U.S. Cl. 345/156; 345/161; 345/158

(57) ABSTRACT

A wireless peripheral for a processor-based device may include a plurality of operators or control buttons that are operated to indicate commands. Those commands may be forwarded over a wireless link in the form of electrical signals to the processor-based device. Operation of the controls or operators may be converted into electrical energy which may be utilized to power the wireless peripheral.

### BACKGROUND

This invention relates generally to wireless devices such as peripherals for processor-based devices including personal computers, processor-based appliances, and game consoles.

In a number of cases, a peripheral or input/output device may be conveniently carried with the user to operate a remote processor-based device. In such case, the user can position himself or herself where desired with greater freedom of movement relative to the controlled processor-based device. Thus, wireless keyboards and mice have become very popular.

Generally, wireless peripherals are battery powered and operate under an appropriate protocol such as a radio frequency or infrared protocol. As long as the user is sufficiently close to a base station or the controlled processor-based device, the processor-based device and the peripheral may communicate, regardless of whether the user moves or not.

Some peripheral devices such as consoles used to control game devices have generally not been amenable to such wireless links. Despite the fact that gaming situations may involve a plurality of users who may prefer to spread out in a room, wireless controls have not been widely adopted. Constant actuation of the gaming controls and the need for frequent and fast communications with the processor-based system that is being controlled means that the power dissipation of the remote control consoles is relatively high. Thus, batteries may have an extremely short life, necessitating constant changes and risking power failures in the middle of games. In addition, the weight involved in providing sufficient battery power to such consoles, may make those consoles somewhat unwieldy.

Thus, there is a need for a better way to power wireless devices in relatively high power consumption applications.

### BRIEF DESCRIPTION OF THE DRAWINGS

FIG. 1 is a perspective view of one embodiment of the present invention;

FIG. 2 is a schematic depiction of one embodiment of the present invention;

FIG. 3 is a front elevational view of the embodiment shown in FIG. 2 in a different position; and

FIG. 4 is a schematic depiction of another embodiment of the present invention.

### DETAILED DESCRIPTION

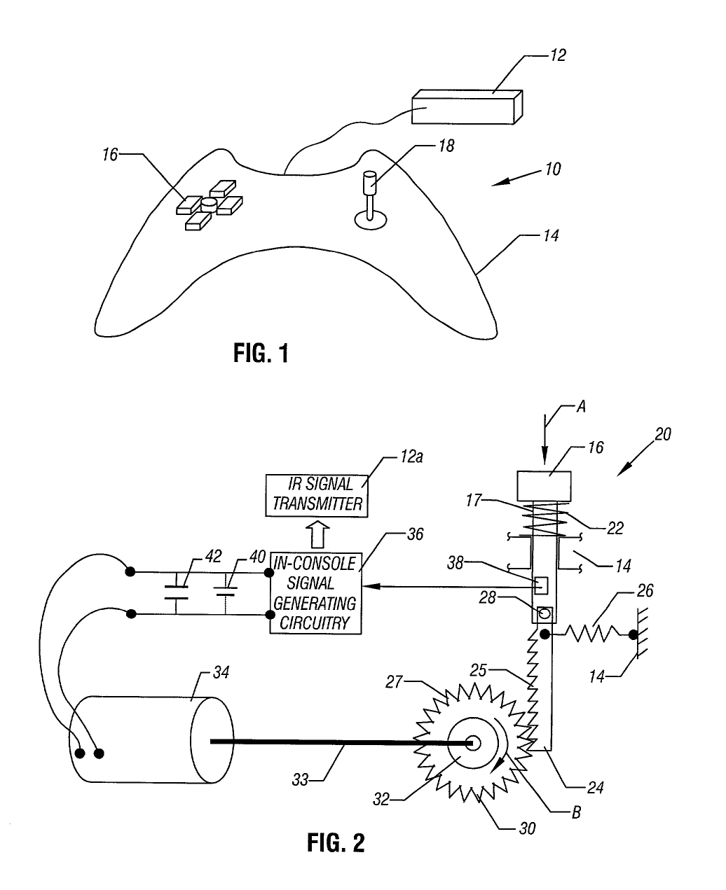

Referring to FIG. 1, a wireless device 10 may communicate with a remote processor-based system over an interface 12. In one embodiment, the interface 12 may be an infrared interface that enables communications with the remote processor-based device using a suitable infrared protocol. Alternatively, the interface 12 may be a radio frequency interface which communicates with a similar interface associated with the processor-based device.

In some embodiments, the wireless device 10 may be a game console that includes selection buttons 16 and a joystick 18. A game console may be utilized to control a processor-based game that is being run on a remote processor-based system.

In other embodiments, the wireless device 10 may be a mouse, a keyboard, or any of a variety of input/output devices for processor-based systems. All that is needed is that the wireless device 10 include controls that are actively operated. The selections that are made through the button 16 and joystick 18 are conveyed to the interface 12 for a transmission to the remote processor-based system (not shown).

Referring to FIG. 2, the wireless device 10 may include an infrared signal transmitter 12a in one embodiment. The transmitter 12a receives signals from an in-console signal generating circuitry 36. The circuitry 36 may be contained within the housing 14 of the device 10 in one embodiment.

When the button 16 is depressed, it compresses a coil spring 22 in one embodiment. The shaft 17 of button 16 is pressed downwardly into the console 14 through an opening therein. Connected to the free end of the shaft 17 is a saw-tooth operator 24. The saw-tooth operator 24 may be coupled to the shaft 17 via a pivoting connection 28. The operator 24 is biased to the left in FIG. 2 by a coil spring 26 coupled to the housing 14. Thus, the operator 24 includes teeth 25 that are biased into engagement with the teeth 27 of a gear wheel 30. The gear wheel 30 may be coupled to a flywheel 22 in some embodiments.

The downward operation of the button 16 results in downward movement of the shaft 17 and the operator 24. The operator 24 is biased into engagement with the teeth 27 of the gear wheel 30. Thus, the translation of the button 16 is converted into rotation in the direction of the arrow D of the gear wheel 30. The rotation of the gear wheel 30 results in rotation of the link 33 around its axis.

A flywheel 32 may be mounted on the gear wheel 30 to increase the energy storage capability of the gear wheel 30. The rotation of the link 33 about its axis results in rotational motion that is converted into electricity by the generator 34.

The potential generated by the generator 34 is supplied across the terminals of a storage capacitor 42. The storage capacitor 42 may then power the in-console generating circuitry 36. The wireless device 10 may produce sufficient power to generate signals for transmission to the remote processor-based device and to operate displays that may reside on the wireless device 10. In some embodiments, depending on the frequency of button 16 operation, an additional battery 40 may be provided as well.

Movement of the button 16 may be detected by a sensor 38 which is also conveyed to the circuitry 36. The signals developed by the circuitry 36 may be passed through the infrared signal transmitter 12a in one embodiment. In other embodiments, transmitters other than infrared signal transmitters may be utilized as described previously.

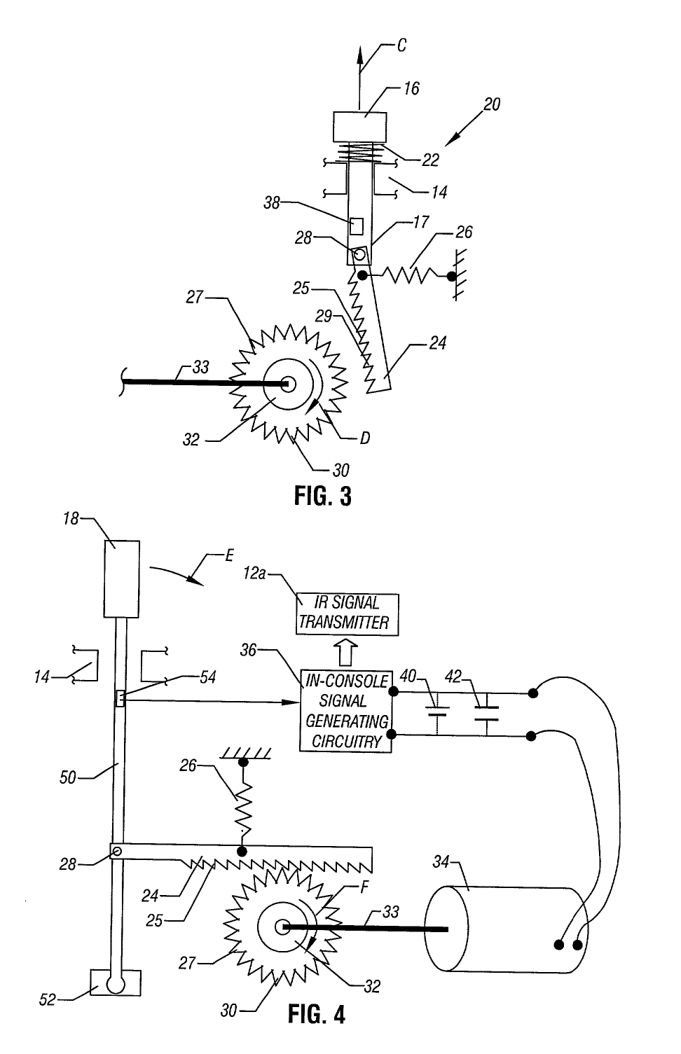

When the button 16 is released, it springs upwardly in the direction of arrow C shown in FIG. 3. That is, the coil spring 22 attempts to return to its initial position by biasing the button 16 upwardly. The upward movement of the button 16 lifts the shaft 17 and operator 24. The upward movement biases the operator 24 against the tension supplied by the coil spring 26 because of the saw-tooth shape of the teeth 25. In particular, the surface 29 of each tooth 25 is biased by the teeth 27 so that the operator 24 is pushed to the right in FIG. 3. Thus, the operator 24 disengages from the gear wheel 30 preventing reverse rotation thereof. In some cases, the gear wheel 30 may continue to spin, for example, under the influence of the flywheel 32, as indicated by the arrow D.

Thus, the repeated actuation of control button 16 on the housing 14 may be converted into potential. The generated potential may be utilized to power the wireless device 10 either without batteries or in conjunction with batteries.

In some embodiments, other control devices may also be equipped with power conversion devices. For example, the joystick 18 may be coupled to a shaft 50 that is mounted on a ball and socket joint 52. Thus, the joystick 18 may be rotated relative to the ball and socket joint 52. Rotation of the shaft 50 may be detected by a sensor 54 and provided to the in-console generating circuit 36. In one embodiment, the circuitry 36 may be coupled to a transmitter 12a.

Rotation of the joystick 18 in the direction of the arrow E in FIG. 4 translates the operator 24 to the right causing the teeth 25 to rotate the gear wheel 30 having teeth 27. Thus, the gear wheel 30 is rotated in the direction indicated by the arrow F causing rotation of the link 33. Again, the rotation of the link 33 powers a generator 34 which produces a charge across the storage capacitor 42. This charge then operates as a power source for the circuitry 36.

When the joystick 38 is operated in a direction opposite the direction E, the operator 24 disengages from the gear wheel 30 in one embodiment. In some cases, additional operators 24 may be utilized to capture the available energy in all directions of displacement of the joystick 18.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
providing a wireless device for a processor-based device;
generating power in the device from the operation of a control operator of the device.

2. The method of claim 1 wherein providing a device includes providing a game console including pushbutton operators and a joystick.

3. The method of claim 2 including generating power through the operation of said pushbuttons.

4. The method of claim 3 including generating power through operation of said joystick.

5. The method of claim 1 including sending signals from said device to said processor-based device over a wireless protocol.

6. The method of claim 1 including enabling said peripheral to run off of power generated through operation of a control operator and a battery.

7. The method of claim 1 including enabling operation of a control operator in the course of playing an electronic game to generate power for the peripheral.

8. A wireless device comprising:
a housing;
a control operator to provide input signals, said operator located on said housing;
a mechanism to generate power in response to the operation of said control operator.

9. The device of claim 8 wherein said device is a wireless peripheral for a processor-based system.

10. The device of claim 8 wherein said device includes a infrared interface.

11. The device of claim 8 wherein said device includes a radio frequency interface.

12. The device of claim 8 wherein said device is an electronic game console.

13. The device of claim 8 wherein said control operator is a pushbutton.

14. The device of claim 8 wherein said control operator is a joystick.

15. The device of claim 8 including an auxiliary battery.

16. A wireless device comprising:
a housing;
an input device associated with said housing; and
a mechanism to generate power in response to operation of said input device.

17. The device of claim 16 including an infrared interface.

18. The device of claim 16 including a radio frequency interface.

19. The device of claim 16 wherein said input device is a pushbutton.

20. The device of claim 8 wherein said wireless device is a game console for an electronic game.
